(19) United States
(12) Patent Application Publication
(10) Pub. No.: US 2018/0202620 A1
(43) Pub. Date: Jul. 19, 2018

(54) LIGHTED ANIMALS

(71) Applicant: Alpine Corporation, Los Angeles, CA (US)

(72) Inventor: Sohrab Robby Soofer, Beverly Hills, CA (US)

(21) Appl. No.: 15/407,016

(22) Filed: Jan. 16, 2017

(51) Int. Cl. F21S 4/20; F21S 9/03; F21V 23/06; F21V 21/08; F21V 3/02

(52) U.S. Cl. CPC F21S 4/20; F21S 9/032; F21S 9/035; F21W 2121/00; F21V 21/0824; F21V 3/02; F21V 23/06

(57) ABSTRACT

Provided is a decorative animal having a body, a leg, a neck, and a head, the neck of the animal comprising a transparent or translucent tubular body inside of which a source of light connected to a power source is placed. Provided is a decorative animal having a body, a leg, at least one foot, a neck, and a head, the leg of the animal comprising a transparent or translucent tubular body inside of which a source of light connected to a power source is placed, the tubular body connected at a top end to the body and at a lower end to the foot. Provided is a decorative insect having elements selected from the group consisting of: a) a body and one or more wings, wherein the body of the insect comprises a transparent or translucent tubular body inside of which a source of light connected to a power source is placed; and b) a body and one or more wings, and a tail, wherein the tail of the insect comprises a transparent or translucent tubular body inside of which a source of light connected to a power source is placed.

### BACKGROUND SECTION OF THE INVENTION

People often use novelties in form of animals for decorate their home and garden. A problem with these novelties is that they are not typically not useful at nights. There is a need in the art for novelties in form of animals that can be used day and night.

### SUMMARY SECTION OF THE INVENTION

Provided is a decorative animal comprising a body, a leg, a neck, and a head, the neck of the animal comprising a transparent or translucent tubular body inside of which a source of light connected to a power source is placed. The animal can further comprise a solar panel for recharging the power source. The solar panel can be placed on top of the body of the animal. The leg can be made with a second tubular body inside of which a source of light connected to a power source is placed. The lower end of the leg can be attached to a stake. The head can be transparent or translucent, and can be lighted by a light source placed on top end of the neck. The animal can be a bird. The animal can further comprise a source of light placed inside of the body. The source of light can be placed inside the body of the animal is a string of lights.

Provided is a decorative animal comprising a body, a leg, at least one foot, a neck, and a head, the leg of the animal comprising a transparent or translucent tubular body inside of which a source of light connected to a power source is placed, the tubular body connected at a top end to the body and at a lower end to the foot. The animal can be a frog or a dog. The decorative animal can further comprise a source of light placed inside of the body. The source of light placed inside the body of the animal can be a string of lights.

Provided is a decorative insect comprising elements selected from the group consisting of: a) a body and one or more wings, wherein the body of the insect comprises a transparent or translucent tubular body inside of which a source of light connected to a power source is placed; and b) a body and one or more wings, and a tail, wherein the tail of the insect comprises a transparent or translucent tubular body inside of which a source of light connected to a power source is placed. The head can be transparent or translucent, and can be lighted by a light source placed on top end of the body. The top end of the tubular body can be a connector to which the head and the wings of the insect are attached. The top end of the tubular body can be a connector to which the body of the insect is attached. The body can be transparent or translucent, and can be lighted by a light source placed on top end of the tail. The decorative animal can further comprise a source of light placed inside of the body. The source of light placed inside the body of the animal can be a string of lights.

### BRIEF DESCRIPTION OF THE DRAWINGS

FIG. 1 illustrates a bird, in this case a flamingo.

FIG. 2 illustrates a frog with a body.

FIG. 3 illustrates an insect.

FIG. 4 illustrates a dog.

FIG. 5 illustrates a bird, in this case a flamingo.

FIG. 6 illustrates an insect, in this case a dragonfly.

FIG. 7 illustrates a butterfly where the body of the butterfly is made of a tubular member.

FIG. 8 illustrates a frog.

FIG. 9 illustrates a frog.

FIG. 10 illustrates an electric circuit.

FIG. 11 illustrates an electric circuit.

### DETAILED DESCRIPTION SECTION OF THE INVENTION

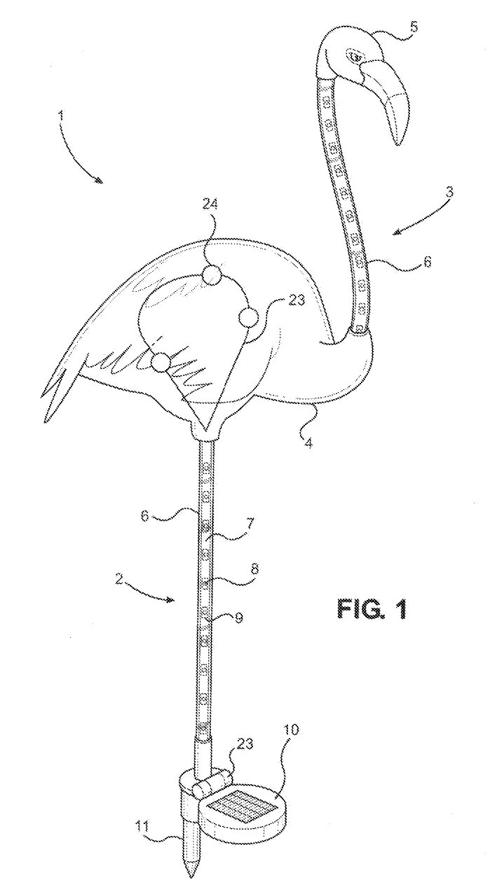

FIG. 1 illustrates a bird 1, in this case a flamingo, standing on a leg 2. The flamingo 1 has a body 4 that is attached to appendages, in this case a neck and a leg. In this case the appendages are formed by a tubular member with a light source. In front and of the body 4, a tubular member 6 with a hollow cavity (bore) forms the neck 3 of the flamingo 1, and a head 5 is placed on tubular member 6 forming the neck 3. At the bottom of the body, another tubular body is placed forming the leg of the flamingo. The bottom of the tubular body 6 forming the leg is attached to a foot in the shape of a stake 11 that can optionally also hold a solar panel 10.

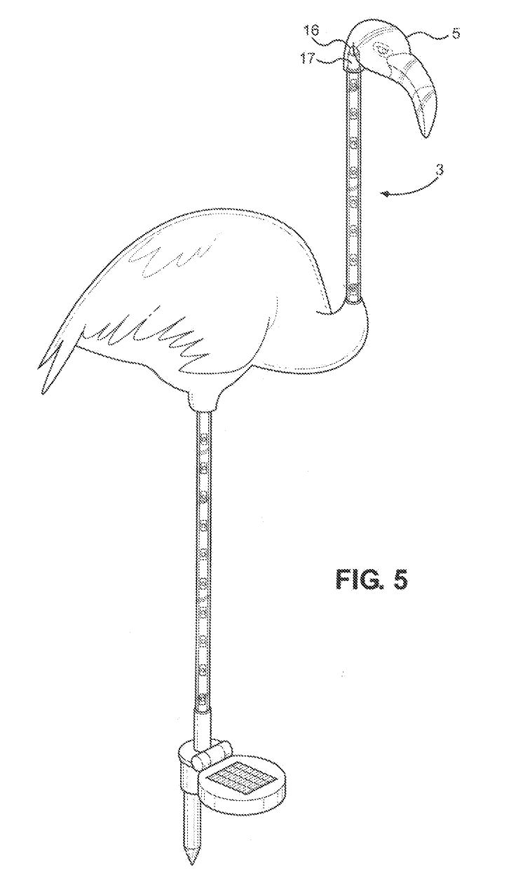

FIG. 5 illustrates a similar embodiment is FIG. 1 except that the neck 3 is formed from a straight tubular member 6 on which a transparent or translucent head 5 rests. The top of the tubular body has a light 16 in connector 17 that lights up the head 5 of the flamingo 1. Connector 17 plugs the end of the tubular member and provides a place for securing head 5.

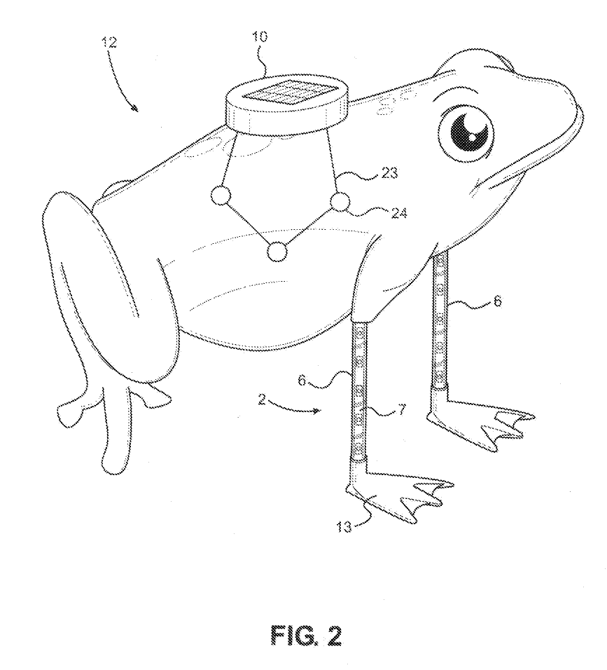

FIG. 2 illustrates a frog 12 with body 4. The front two legs 2 are formed by a tubular member 6 containing a source of light therein. The tubular member 6 is the attached to the feet 13 of the frog 12. A solar panel 10 is placed on top of the body of the frog 12.

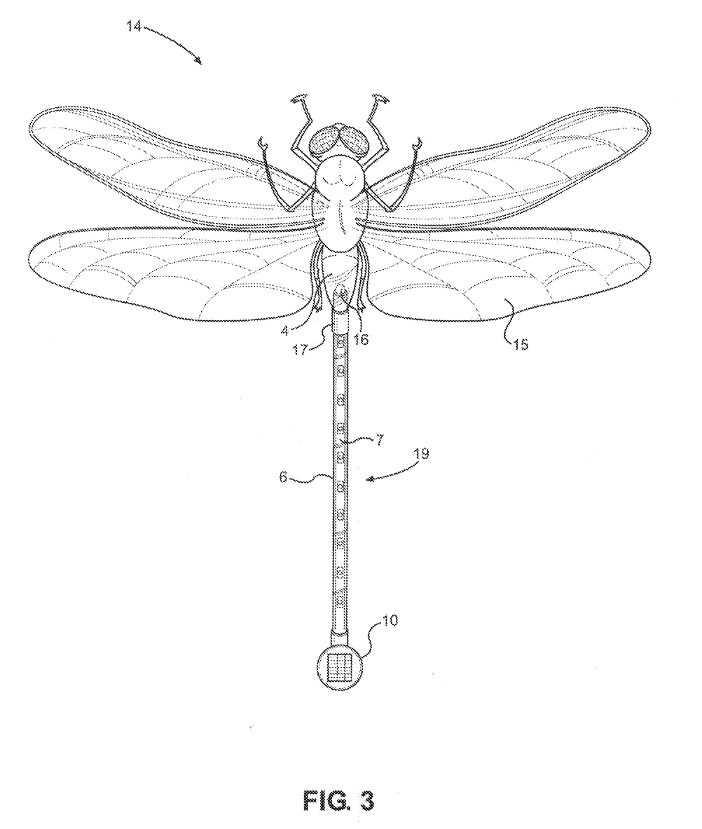

FIG. 3 illustrates an insect 14, in this case a dragonfly. The tail 19 of the insect 14 is made from a tubular member 6 having a source of light therein. The body 4 of the insect 14 that is attached to the tubular member 6 can be transparent or translucent, resulting in the body being lighted by a light on top 16 of the tubular member 6. A solar panel 10 can be attached to other end of the tubular member 6.

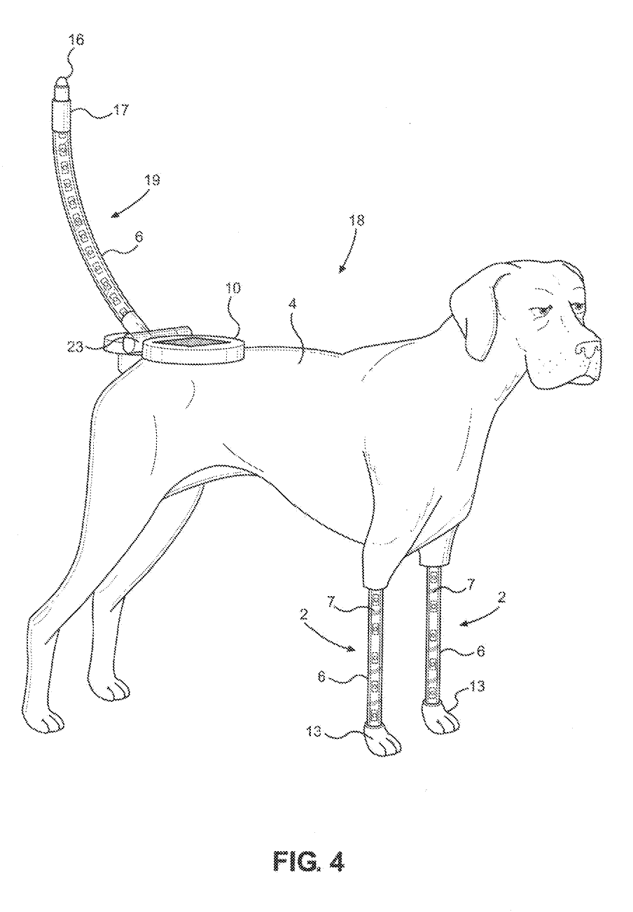

FIG. 4 illustrates a dog 18 with a tubular member 6 that forms the front legs 2 of the dog 18. The tail of the dog 18 is made from a curved or straight tubular member 6. A solar panel 10 can be placed on top of the body of the dog 18. One end of tubular member 6 can be placed in a receiving cavity in feet 13 of the dog. A stake 11 can also be in place of feet 13. The other end of tubular member 6 can be placed in a cavity formed on the body of the dog that can represent the thighs or upper portion of the leg of the dog 18. The tail of the dog 18 can have a light 16 at its end and a connector 17 for placement of transparent or translucent topper.

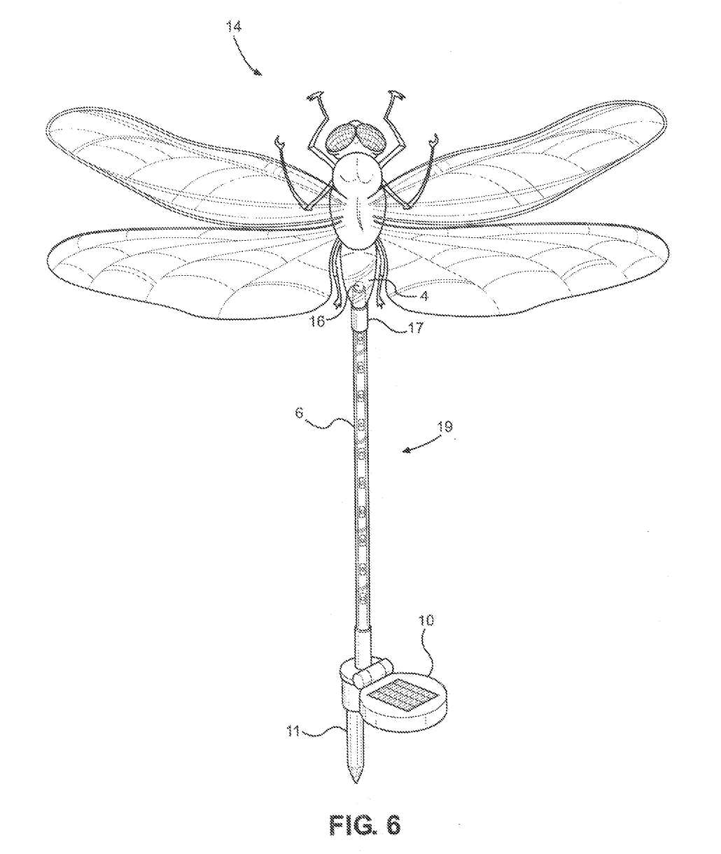

FIG. 6 illustrates an insect 14, in this case a dragonfly 14, where the tail 19 of the dragonfly 14 is made of a tubular member 6 that is connected to a stake 11 for attaching to the ground. In this embodiment, the dragonfly 14 has a transparent or translucent body 4, which is placed at one end of tubular body 6. Tubular body 6 can have a light 16 at its end and a connector 17 for placement of transparent or translucent body 4. As shown in FIG. 6, body 4 and tail 19 are oriented in the same direction.

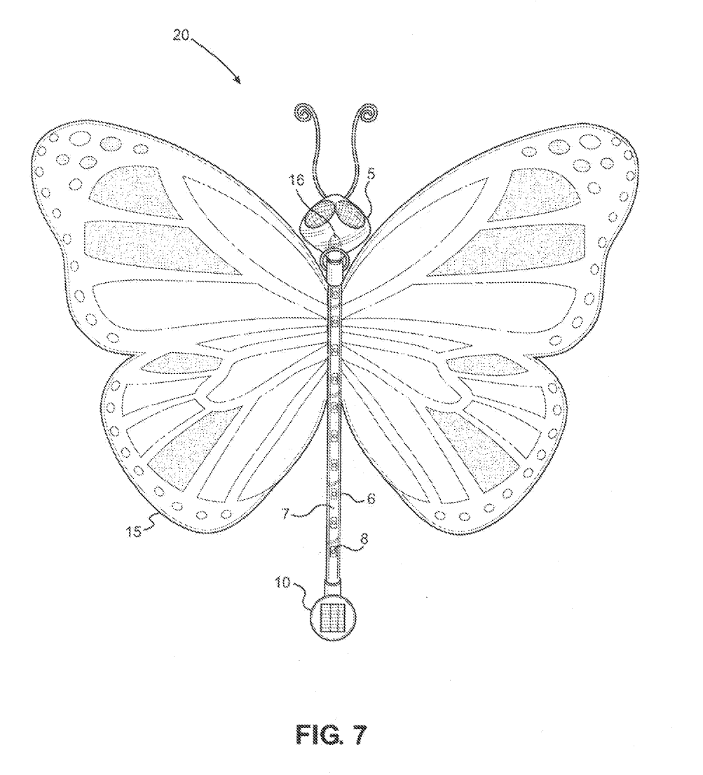

FIG. 7 illustrates a butterfly 20 where the body of the butterfly is made of a tubular member 6, which can be connected to solar panel or a stake. Tubular body 6 can have a light 16 at its end and a connector 17 for placement of transparent or translucent head 5. Wings 15 can be connected to tubular member 6 by attachment to connector 16. For example, wings 15 can have a ring that sits on connector 17.

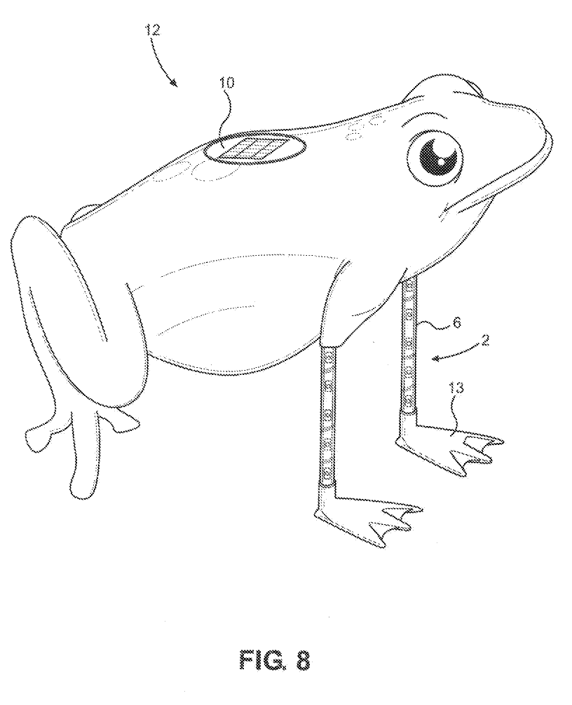

FIG. 8 illustrates a frog 12 where the front two legs 2 of the frog are made from tubular members 6 having a light therein. The tubular member 6 has two ends, with one end placed in feet 13 and other end placed in a cavity on the body of the frog. The cavity can be downwardly positioned, and be part of the upper leg portion or thigh of the frog 6. A solar panel 10 is placed on top of the body of from 16 in a horizontal position. The upper body of frog 12 can have a cavity or opening that receives the solar panel 10. Solar panel 10 can be contoured or straight, and/or be substantially flush with body of frog 12.

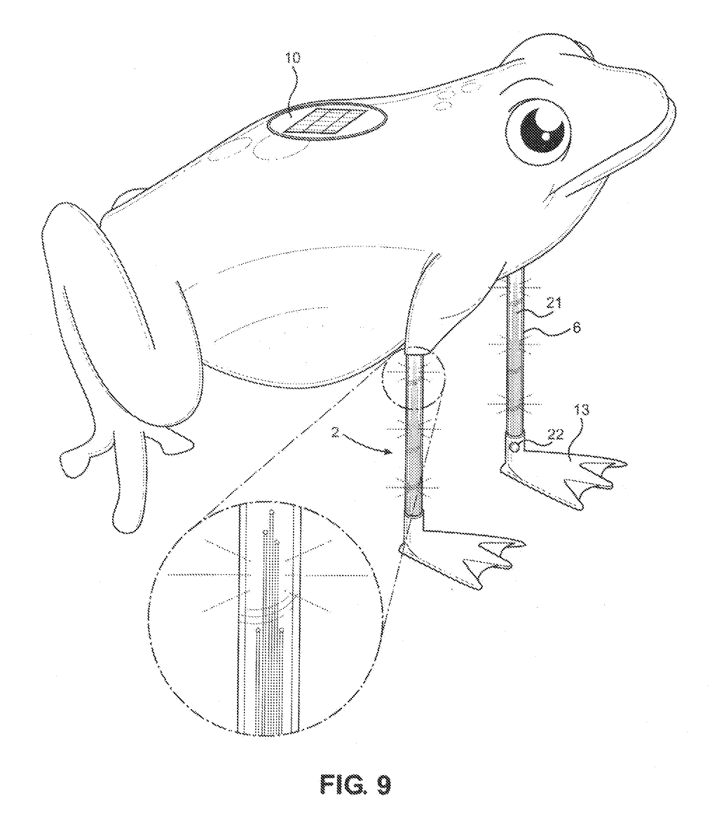

FIG. 9 illustrates a frog where the front two legs of the frog are made from tubular members having a light therein. In this case, the lights are made of fiber optic 21 bundles that transmit light from a light source 22, which is placed in feet 13 and is hidden from view. The fiber optics can terminate at different lengths. The bundle of optical fibers 21 can be optically connected to a light source that is placed inside of the second connector.

A hidden light source 22, such as a light-emitting diode (LED), can be placed facing upright and hidden from view in feet 13, which are typically made from opaque plastic.

A separate metal wire (not illustrated) can electronically connect the hidden light source 22 or light source 16 to the rechargeable battery 40. The separate metal wire can be either connected to the strip or directly to the battery.

The strip 7 light sources can be light-emitting diodes (LEDs) or other sources of light. The strip light sources can be electronically connected to the strip using metal wires. The strip can have a flash control integrated circuit chip (herein after a “flash control IC”) that is used to program a lighting effect in the strip. The flash control IC can be programmed and used to control and light up, in a step-by-step flashing mode, each strip light source starting from the bottom of the tube and moving upwards. The lighting effect is programmed to go from the bottom of the tube to the top of the tube in predetermined time intervals (i.e. T1, T2, T3, etc). When the light reaches the top, it lights up the light source (such as an LED bulb) at the top of the connector. In one embodiment, the strip light sources produce a single color, while in another embodiment, each strip light source is capable of producing multiple colors. In another embodiment, strip light sources with at least two different colors are used. The flash control IC is electronically connected to and powered by the rechargeable battery. When an internal switch and/or an external switch is turned on, the flash control IC is activated. The strip can have openings 9 that allow each strip light source 8 to be visible from both opposite sides of the strip 7.

The decorative topper element 18 (here in the form of a bird, although other animals and objects can be used) that is transparent or translucent. The decorative element 18 detachably connects to the second tubular part 5 of the first connector 4. The light source 3 at the top of the first connector 4 lights up the inside of the decorative element 18. The decorative element 18 can be attached in a similar fashion to the tube 1 of FIG. 2.

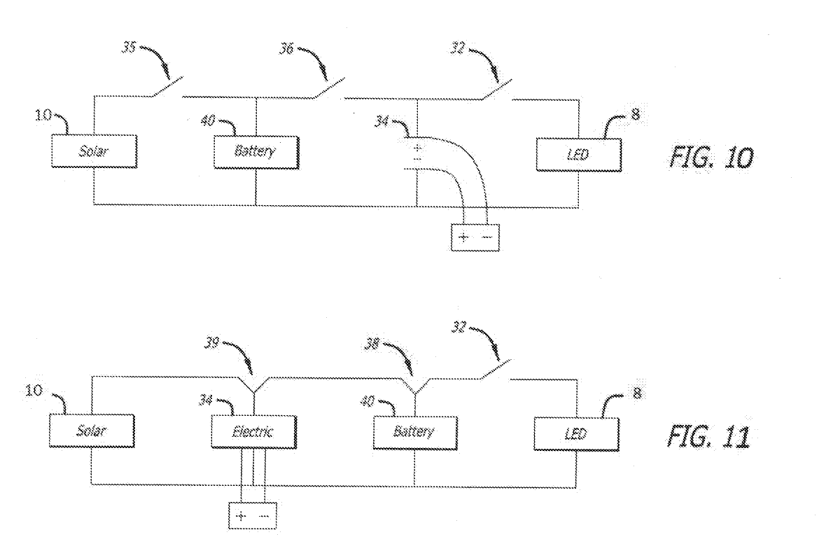

FIG. 10 illustrates an exemplary circuit diagram of control circuitry. There is provided solar panels 10, a rechargeable battery 40, and an optional connection to an external source of electricity 34 such as from an electrical outlet. The light source 8, such as a light-emitting diode (LED), is connected to the control circuitry. The flow of current is controlled by the on-off switch 32 and internal switches 35 and 36. In one embodiment, on-off switch 32 can be an internal switch. In another embodiment, on-off switch 32 can be an external killer switch.

FIG. 11 illustrates an alternate embodiment of an exemplary circuit diagram of control circuitry in the solar panel housing 8. The circuit in FIG. 11 operates substantially similar to the circuit in FIG. 10, except that the positions of the rechargeable battery 40 and external source of electricity 34 are reversed, and internal switches 35 and 36 are replaced with internal dual switches 38 and 39. Internal switches can turn on the lights when ambient light falls below a certain threshold.

The animal body or other parts can be made from resin, polymer, plastic or other materials that can be transparent or translucent. A string of light 23 in series having a plurality of light sources 24 (LEDs) can be placed inside the body of the animal so that the body of the animal lights up (FIGS. 1 and 2).
1. Bird
2. Leg
3. Neck
4. Body
5. Head
6. tubular member
7. strip
8. light source (LED)
9. opening in strip
10. solar panel
11. stake
12. frog
13. feet
14. insect
15. wings
16. light source (LED) on top
17. connector
18. dog
19. tail
20. butterfly
21. fiber optic
22. hidden light source
23. string of light
24. light sources
32. on-off switch
34. external source of electricity
35. internal switches
36. internal switches
40. rechargeable battery

What is claimed is:

1. A decorative animal comprising a body, a leg, a neck, and a head, the neck of the animal comprising a transparent or translucent tubular body inside of which a source of light connected to a power source is placed.

2. The decorative animal of claim 1, wherein the animal further comprises a solar panel for recharging the power source.

3. The decorative animal of claim 1, wherein the solar panel is placed on top of the body of the animal.

4. The decorative animal of claim 1, wherein the leg is made with a second tubular body inside of which a source of light connected to a power source is placed.

5. The decorative animal of claim 1, wherein a lower end of the leg is attached to a stake.

6. The decorative animal of claim 1, wherein the head is transparent or translucent, and is lighted by a light source placed on top end of the neck.

7. The decorative animal of claim 1, wherein the animal is a bird.

8. The decorative animal of claim 1, further comprising a source of light placed inside of the body.

9. The decorative animal of claim 8, wherein the source of light placed inside the body of the animal is a string of lights.

10. A decorative animal comprising a body, a leg, at least one foot, a neck, and a head, the leg of the animal comprising a transparent or translucent tubular body inside of which a source of light connected to a power source is placed, the tubular body connected at a top end to the body and at a lower end to the foot.

11. The decorative animal of claim 10, wherein the animal is a frog or a dog.

12. The decorative animal of claim 10, further comprising a source of light placed inside of the body.

13. The decorative animal of claim 12, wherein the source of light placed inside the body of the animal is a string of lights.

14. A decorative insect comprising elements selected from the group consisting of:
a) a body and one or more wings, wherein the body of the insect comprises a transparent or translucent tubular body inside of which a source of light connected to a power source is placed, and b) a body and one or more wings, and a tail, wherein the tail of the insect comprises a transparent or translucent tubular body inside of which a source of light connected to a power source is placed.

15. The decorative animal of claim 14, wherein the head is transparent or translucent, and is lighted by a light source placed on top end of the body.

16. The decorative animal of claim 14, wherein the top end of the tubular body has a connector to which the head and the wings of the insect are attached.

17. The decorative animal of claim 14, wherein the top end of the tubular body has a connector to which the body of the insect is attached.

18. The decorative animal of claim 14, wherein the body is transparent or translucent, and is lighted by a light source placed on top end of the tail.

19. The decorative animal of claim 14, further comprising a source of light placed inside of the body.

20. The decorative animal of claim 19, wherein the source of light placed inside the body of the animal is a string of lights.
